(19) United States
(12) Patent Application Publication
(10) Pub. No.: US 2025/0341401 A1
(43) Pub. Date: Nov. 6, 2025

(54) MOVABLE APPARATUS CONTROL DEVICE, STORAGE MEDIUM, AND MOVABLE APPARATUS CONTROL METHOD

(71) Applicant: CANON KABUSHIKI KAISHA, Tokyo (JP)

(72) Inventors: Shoji YONEHATA, Kanagawa (JP); Kazuhiko KOBAYASHI, Kanagawa (JP)

(21) Appl. No.: 19/269,348

(22) Filed: Jul. 15, 2025

Related U.S. Application Data
(63) Continuation of application No. PCT/JP2023/046587, filed on Dec. 26, 2023.

(30) Foreign Application Priority Data
Jan. 26, 2023 (JP) 2023-010139

(51) Int. Cl. G01C 21/00; B60W 60/00

(52) U.S. Cl. CPC G01C 21/38; B60W 60/001; B60W 2556/50

(57) ABSTRACT

A movable apparatus control device comprising: a first condition data acquisition unit configured to acquire first condition data that indicates a condition employed in generation of map data showing a map used when a movable apparatus moves autonomously through a space; a second condition data acquisition unit configured to acquire second condition data that indicates a condition employed when the movable apparatus moves autonomously through the space using the map data; a non-map data acquisition unit configured to acquire non-map data that indicates content different from the map, in cases where the condition indicated by the first condition data and the condition indicated by the second condition data do not match within a prescribed range; and a data provision unit configured to provide the non-map data to the movable apparatus.

### CROSS-REFERENCE TO RELATED APPLICATIONS

This application is a Continuation of International Patent Application No. PCT/JP2023/046587, filed Dec. 26, 2023, which claims the benefit of Japanese Patent Application No. 2023-010139, filed Jan. 26, 2023, both of which are hereby incorporated by reference herein in their entirety.

### BACKGROUND

### Field of the Technology

The present disclosure relates to a movable apparatus control device, a storage medium, a movable apparatus control method, and the like.

### Background Art

Currently, the use of autonomous moving type robots such as autonomous mobile robots (AMRs), which move autonomously in various places such as office buildings, houses, factories, commercial facilities, and warehouses to perform predetermined actions such as work, is becoming widespread.

Such a movable apparatus estimates its own position on the basis of the results of measuring a space using sensors and a map of the space, and moves autonomously through the space while creating the map of the space to perform predetermined actions. In addition, such a map is accompanied by conditions such as types and performances of the sensors used to generate the map, a brightness in the space, and a time at which the map was generated.

However, if a movable apparatus moves autonomously through a space under conditions that are greatly different from conditions associated with a map, it becomes difficult to ascertain a correspondence between the results of measuring the space using sensors and the map of the space.

Accordingly, in such a case, the movable apparatus may not be able to estimate its own position with sufficient accuracy.

An information processing device according to Japanese Patent Laid-Open No. 2019-125354 determines a position of a movable apparatus on the basis of a first processing result and a second processing result. The first processing result is obtained by processing an image, which is obtained by measuring surroundings of the movable apparatus using a light receiving sensor mounted on the movable apparatus, by a first processing method.

The second processing result is obtained by processing an observation result, which is obtained by observing the movable apparatus using a light receiving sensor installed at a place at which the movable apparatus can be observed, by a second processing method that is different from the first processing method.

An autonomous movable apparatus patrol system according to Japanese Patent Laid-Open No. 2003-295951 includes a camera, an image processing unit, and a coordinate calculation unit. The camera is fixed at a position for imaging a region that includes a patrol course, and images a security robot. The image processing unit determines a position of the autonomous movable apparatus in the captured image. The coordinate calculation unit calculates an actual position of the security robot. Then, the security robot uses the calculated actual position to correct an estimated current position. However, the techniques disclosed in the above-described documents are all premised on the use of a map for movement. For this reason, these two technologies may cause a situation in which a movable apparatus is unable to estimate its own position with sufficient accuracy when conditions relating to a space when a map was generated are greatly different from conditions relating to a space when the movable apparatus moves autonomously.

Also, the map may not always be updated when the conditions relating to the space when the map was generated are greatly different from the conditions relating to the space when the movable apparatus moves autonomously.

### SUMMARY

A movable apparatus control device according to one aspect of the present disclosure includes: a first condition data acquisition unit configured to acquire first condition data that indicates a condition when map data that indicates a map used when a movable apparatus moves autonomously through a space is generated; a second condition data acquisition unit configured to acquire second condition data that indicates a condition when the movable apparatus moves autonomously through the space using the map data; a non-map data acquisition unit configured to acquire non-map data that indicates a content different from the map in a case in which the condition indicated by the first condition data and the condition indicated by the second condition data do not match within a predetermined range; and a data provision unit configured to provide the non-map data to the movable apparatus.

### BRIEF DESCRIPTION OF THE DRAWINGS

FIG. 1 is a diagram showing an example of a configuration of a movable apparatus system according to a first embodiment.

FIG. 2 is a diagram showing an example of a hardware configuration of a movable apparatus control device or the like according to the first embodiment.

FIG. 3 is a diagram showing an example of a software configuration of the movable apparatus control device according to the first embodiment.

FIG. 4 is a flowchart showing an example of processing executed by the movable apparatus control device according to the first embodiment.

FIG. 5 is a flowchart showing an example of processing executed by a movable apparatus control device according to a second embodiment.

FIG. 6 is a flowchart showing an example of processing executed by a movable apparatus control device according to a third embodiment.

FIG. 7 is a schematic diagram of a configuration of the movable apparatus system according to the first embodiment.

### DESCRIPTION OF THE EMBODIMENTS

### First Embodiment

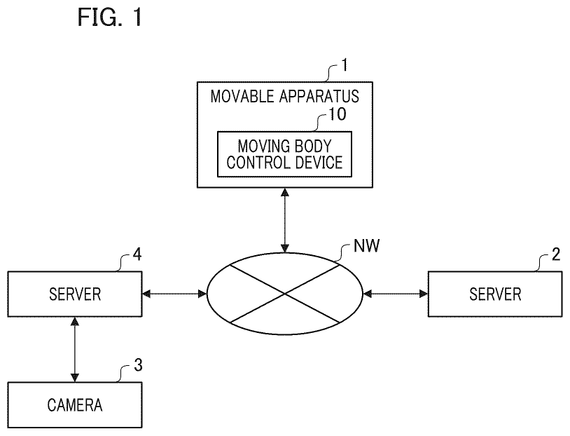

A first embodiment of the present disclosure will be described below with reference to FIGS. 1 to 4. FIG. 1 shows an example of a configuration of a movable apparatus system for the first embodiment. FIG. 1 shows a movable apparatus 1, a server 2, a camera 3, and a server 4.

The movable apparatus 1 is, for example, an automated guided vehicle (AGV), an autonomous moving transport robot, or the like that performs predetermined actions such as security, cleaning, and freight transportation in a space of a building such as an office building, a house, a factory, a warehouse, or the like.

Also, the movable apparatus 1 includes a drive mechanism and an angular velocity sensor. The drive mechanism is a mechanical mechanism required to drive the movable apparatus 1 and includes a motor, a shaft, gears, belts, wheels, actuators, and the like. The angular velocity sensor measures a speed of the movable apparatus 1 by measuring an angular velocity of the wheels or the like of the movable apparatus 1.

The movable apparatus 1 is equipped with a sensor, and estimates its own position and posture by simultaneous localization and mapping (SLAM) or the like using this sensor, thereby ascertaining a space around it, moving autonomously within the space, and performing predetermined actions. SLAM is a technology in which the movable apparatus 1 simultaneously performs processing of estimating its own position and processing of generating a map around the movable apparatus 1.

The above-described sensor is, for example, a two-dimensional or three-dimensional light detection and ranging (LIDAR), a Time of Flight (ToF) type sensor, or a stereo camera.

The LIDAR ascertains positions, dimensions, shapes, and the like of each object present in the space by measuring distances to each point on each object present in the space using pulsed near-infrared laser light and generating point cloud data.

The ToF type sensor measures a distance to an object by measuring the time it takes for light output from a light source to be reflected by the object in the space and input to a photo-detector. In this way, the ToF type sensor ascertains positions, dimensions, shapes, and the like of each object in the space.

The stereo camera ascertains positions, dimensions, shapes, and the like of each object in the space by measuring distances to each point on each object present in the space on the basis of a triangulation method using two cameras to generate a set of feature points.

The movable apparatus 1 requires a map of the space when moving autonomously through the space. This map is, for example, data obtained by expressing an interior of the space as two-dimensional or three-dimensional point cloud data using LIDAR, or data obtained by expressing as a set of two- or three-dimensional feature points of recognized objects using a stereo camera. Also, in the following description, the data that indicates the map used by the movable apparatus 1 will be referred to as map data.

The movable apparatus 1 includes a movable apparatus control device 10 shown in FIG. 1. The movable apparatus control device 10 acquires first condition data, second condition data, and non-map data, which will be described later, determines a use of the non-map data, and provides the movable apparatus 1 with the non-map data and use data, which will be described later.

In addition, the movable apparatus control device 10 can communicate with the server 2 and the server 4 via a network NW. Also, details of the movable apparatus control device 10 will be described later. Further, the network NW may be a wired network or a wireless network, but is preferably a wireless network.

The server 2 manages the map data that indicates the map used when the movable apparatus 1 moves autonomously through the space. In addition, the server 2 can communicate with the movable apparatus control device 10 or the server 4 via the network NW shown in FIG. 1.

The map data is, for example, generated before the movable apparatus 1 moves autonomously through the space and stored in a storage medium managed by the server 2. Then, the map data is acquired by the movable apparatus control device 10 when the movable apparatus 1 starts moving autonomously in the space.

The camera 3 is, for example, a network camera installed in such a manner that it can capture images from above in a direction of looking down at the space in which the movable apparatus 1 performs predetermined actions. The camera 3 captures still or moving images of at least a part of the space and generates image data showing the still or moving images.

The image data is sent, for example, to the server 4 and stored in a storage medium managed by the server 4. Also, the camera 3 does not necessarily have to be operated for the purpose of contributing to the movable apparatus 1, and may be operated for other purposes such as surveillance, security, or the like of a building. In addition, the camera 3 may be managed by, for example, an administrator different from at least one of administrators of the movable apparatus 1 and the server 2.

The server 4 manages the image data generated by the camera 3. For example, the server 4 stores the image data on the storage medium managed by itself. In addition, the server 4 can communicate with the movable apparatus control device 10 or the server 2 via the network NW shown in FIG. 1. Also, the server 4 may be managed by, for example, an administrator different from at least one of administrators of the movable apparatus 1 and the server 2.

Also, if the camera 3 is operated for the purpose of surveillance, security, or the like of a building, the server 4 may process the still or moving images shown by the image data in accordance with the purpose of protecting privacy, protecting confidential information, or the like.

Examples of such a process include, for example, processing of superimposing a mask image on a face or whole body of a person shown in a still or moving image, or processing of replacing a person shown in a still or moving image with an image with a high level of abstraction such as an icon.

In particular, when the server 4 is managed by an administrator different from at least one of administrators of the movable apparatus 1 and the server 2, the server 4 preferably processes the still or moving images shown by the image data.

Further, the server 4 may not provide the image data to the movable apparatus control device 10 in accordance with a level of security attached to the still or moving images shown by the image data. Also, such a level of security may change over time.

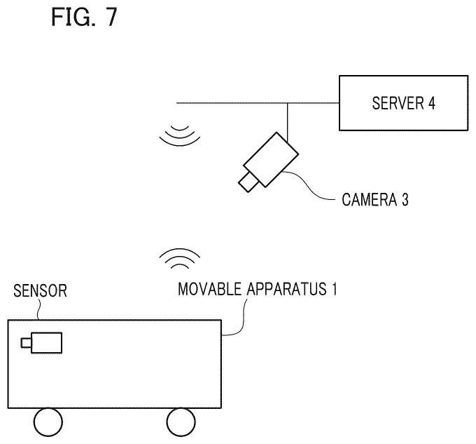

FIG. 7 is a schematic diagram of a configuration of the movable apparatus system according to the first embodiment. The movable apparatus 1 is equipped with the above-described sensor and is connected to the network NW so that it can communicate with the server 2 and the server 4.

As described above, the server 2 manages the map data used by the movable apparatus 1 for traveling. As described above, the server 4 manages the image data generated by the camera 3. In the present embodiment, the movable apparatus 1 travels on the basis of the map data notified from the above-described server 2 and the moving images notified from the server 4.

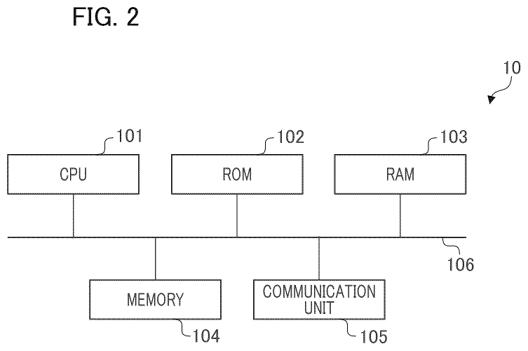

Next, a hardware configuration of the movable apparatus control device according to the first embodiment will be described with reference to FIG. 2. FIG. 2 is a diagram showing an example of the hardware configuration of the movable apparatus control device or the like according to the first embodiment.

As shown in FIG. 2, the movable apparatus control device 10 includes a central processing unit (CPU) 101, a read only memory (ROM) 102, a random access memory (RAM) 103, a memory 104, a communication unit 105, and a bus 106.

The CPU 101 reads and executes a program, thereby realizing each function of the movable apparatus control device 10. The ROM 102 is a recording medium in which the program read and executed by the CPU 101 is stored.

The RAM 103 is a recording medium in which the programs read and executed by the CPU 101 are temporarily loaded. The memory 104 is, for example, a hard disk drive (HDD), which stores various pieces of data and various programs, and may store programs read and executed by the CPU 101.

The communication unit 105 performs communication with the server 2 or the server 4 via the network NW shown in FIG. 1. The bus 106 connects the CPU 101, the ROM 102, the RAM 103, the memory 104, and the communication unit 105 in a manner that allows them to communicate with each other.

Also, the server 2 includes a CPU, a ROM, a RAM, a memory, a communication unit, and a bus. The CPU reads and executes a program, thereby realizing each function of the server 2.

The ROM is a recording medium in which a program read and executed by the CPU is stored. The RAM is a recording medium in which a program read and executed by the CPU is temporarily loaded.

The memory is, for example, a hard disk drive, which stores various databases and various programs, and may store the program read and executed by the CPU. The communication unit performs communication with the movable apparatus control device 10 or the server 4. The bus connects the CPU, the ROM, the RAM, the memory, and the communication unit in a manner that allows them to communicate with each other.

Like the server 2, the server 4 includes a CPU, a ROM, a RAM, a memory, a communication unit, and a bus. The CPU reads and executes a program, thereby realizing each function of the server 2.

The ROM is a recording medium in which a program read and executed by the CPU is stored. The RAM is a recording medium in which a program read and executed by the CPU is temporarily loaded.

The memory is, for example, a hard disk drive, which stores various databases and various programs, and may store a program read and executed by the CPU. The communication unit performs communication with the movable apparatus control device 10 or the server 2. The bus connects the CPU, the ROM, the RAM, the memory, and the communication unit in a manner that allows them to communicate with each other.

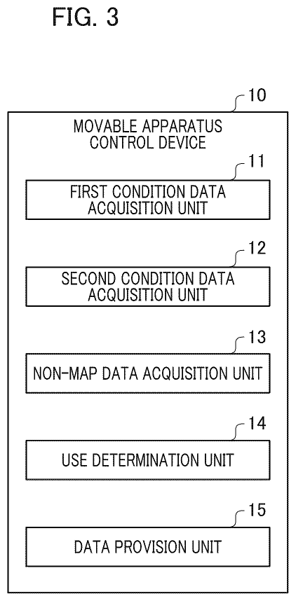

Next, a software configuration of the movable apparatus control device according to the first embodiment will be described with reference to FIG. 3. FIG. 3 is a diagram showing an example of the software configuration of the movable apparatus control device according to the first embodiment.

As shown in FIG. 3, the movable apparatus control device 10 includes a first condition data acquisition unit 11, a second condition data acquisition unit 12, a non-map data acquisition unit 13, a use determination unit 14, and a data provision unit 15.

The first condition data acquisition unit 11 acquires the first condition data that indicates a condition when the map data that indicates the map used when the movable apparatus 1 moves autonomously through the space is generated.

For example, the first condition data may indicate at least one of a type of sensor and a performance of the sensor used to generate the map data. The type of sensor here may be, for example, a type of LIDAR, a ToF type sensor, a stereo camera, or the like, or a type of sensor that performs two-dimensional measurement or three-dimensional measurement.

Alternatively, the type of sensor here may be at least one of parameters relating to a laser or the like used for measurement, and a position and a posture in which the sensor is attached. The performance of the sensor here may be at least one of a range of at least one of distances and angles that can be measured by the sensor, a resolution of at least one of the distances and the angles that can be measured by the sensor, and at least one of a resolution and a frame rate of an image generated by measurement.

Alternatively, the first condition data may indicate at least one of a type of sensor and a performance of the sensor used by the movable apparatus 1 to detect an obstacle. The type of sensor here may be at least one of parameters relating to a laser or the like used for measurement, and a position and a posture in which the sensor is attached.

The performance of the sensor here may be a range of at least one of a distance and an angle that can be measured by the sensor, a resolution of at least one of the distance and the angle that can be measured by the sensor, and at least one of a resolution and a frame rate of an image generated by measurement.

Alternatively, the first condition data may indicate a brightness around the movable apparatus 1 when the map data was generated. The brightness here is, for example, a luminous intensity, which is an intensity of light emitted in a specific direction from a light source installed in the space, a luminous flux, which is a total amount of light passing through a virtual plane included in the space, or an illuminance, which is a brightness on a virtual plane included in the space.

Alternatively, the brightness here is a spatial change in luminous intensity, a luminous flux, or an illuminance in the space. Alternatively, the brightness here is a luminance of a still or moving image captured around the movable apparatus 1. Also, the luminance is, for example, a statistic of a luminance of a specific portion of a still or moving image.

Alternatively, the first condition data may indicate a time the map data was generated. This time may be, for example, a time period when the map data was generated, or may be a time when the map data was generated, which is expressed in units of one hour, ten minutes, one minute, or the like.

Alternatively, the first condition data may indicate at least some of parameters of an imaging device, such as a stereo camera, that is a sensor used to generate the map data. These parameters are used to convert coordinates indicating a position of an object present in the space on the basis of an image generated by the imaging device.

The second condition data acquisition unit 12 acquires the second condition data that indicates a condition when the movable apparatus 1 moves autonomously through the space using the map data.

For example, the second condition data may indicate at least one of a type of sensor and a performance of the sensors used by the movable apparatus 1 to move autonomously through the space. The type of sensor here may be, for example, a type of LIDAR, a ToF type sensor, a stereo camera, or the like, or a type of sensor that performs two-dimensional measurement or three-dimensional measurement.

Alternatively, the type of sensor here may be at least one of parameters relating to a laser or the like used for measurement, and a position and a posture in which the sensor is attached. The performance of the sensor here may be at least one of a range of at least one of distances and angles that can be measured by the sensor, a resolution of at least one of the distances and the angles that can be measured by the sensor, and at least one of a resolution and a frame rate of an image generated by measurement.

Alternatively, the second condition data may indicate at least one of a type of sensor and a performance of the sensor used by the movable apparatus 1 to detect an obstacle. The type of sensor here may be at least one of parameters relating to a laser or the like used for measurement, and a position and a posture in which the sensor is attached.

The performance of the sensor here may be at least one of a range of at least one of distances and angles that can be measured by the sensor, a resolution of at least one of the distances and the angles that can be measured by the sensor, and at least one of a resolution and a frame rate of an image generated by measurement.

Alternatively, the second condition data may indicate a brightness around the movable apparatus 1 when the movable apparatus 1 moves autonomously through the space. The brightness here is, for example, a luminous intensity, which is an intensity of light emitted in a specific direction from a light source installed in the space, a luminous flux, which is a total amount of light passing through a virtual plane included in the space, or an illuminance, which is a brightness on a virtual plane included in the space.

Alternatively, the second condition data may indicate a time during which the movable apparatus 1 moves autonomously through the space. This time may be, for example, a time period during which the movable apparatus 1 moves autonomously through the space, or may be a time during which the movable apparatus 1 moves autonomously through the space, which is expressed in units of one hour, ten minutes, one minute, or the like.

Also, the second condition data indicates a type of content that overlaps the first condition data. For example, if the type of sensor used to generate the map data is indicated by the first condition data, the second condition data indicates the type of sensor used by the movable apparatus 1 to move autonomously through the space. Also, if the performance of the sensor used to generate the map data is indicated by the first condition data, the second condition data indicates the performance of the sensors used by the movable apparatus 1 to move autonomously through the space.

Alternatively, if the type of sensor used by the movable apparatus 1 to detect an obstacle is indicated by the first condition data, the second condition data indicates the type of sensor used by the movable apparatus 1 to detect the obstacle.

Also, if the performance of the sensor used by the movable apparatus 1 to detect an obstacle is indicated by the first condition data, the second condition data indicates the performance of the sensor used by the movable apparatus 1 to detect the obstacle.

Alternatively, if the brightness around the movable apparatus 1 when the map data was generated is indicated by the first condition data, the second condition data indicates the brightness around the movable apparatus when the movable apparatus 1 moves autonomously through the space. Alternatively, if the time when the map data was generated is indicated by the first condition data, the second condition data indicates the time when the movable apparatus 1 moves autonomously through the space.

Alternatively, the second condition data may indicate at least some of parameters of an imaging device such as a stereo camera used as the sensor when the movable apparatus 1 moves autonomously through the space. These parameters are used to convert coordinates indicating a position of an object present in the space on the basis of an image generated by the imaging device.

The non-map data acquisition unit 13 determines whether the condition indicated by the first condition data and the condition indicated by the second condition data match within a predetermined range. If the condition indicated by the first condition data and the condition indicated by the second condition data do not match within the predetermined range, the non-map data acquisition unit 13 acquires the non-map data that indicates a content different from the map. The non-map data acquisition unit 13 acquires the non-map data from the movable apparatus 1, the server 4, or the like that generates or manages each piece of the non-map data.

The non-map data indicates, for example, the content relating to the sensor used by the movable apparatus 1. Alternatively, the non-map data is image data that indicates an image generated by imaging at least a part of the space with the camera 3.

Also, the image data preferably indicates an image in which the movable apparatus 1 is shown. Examples of techniques for determining whether or not the movable apparatus 1 is shown in the image captured by the camera 3 include, for example, template matching, deep neural network (DNN), and a technique for detecting a marker attached to the movable apparatus 1.

Alternatively, the non-map data shows the result of simulating a brightness of a route along which the movable apparatus 1 should move. This route is a preferred route for the movable apparatus 1 to move accurately in the space and perform predetermined actions.

Also, this route is preferably as short as possible from a point at which the movable apparatus 1 starts moving to a point at which the movable apparatus 1 ends moving. In addition, this route preferably allows the movable apparatus 1 to move as smooth as possible.

Further, the result of the above-described simulation is, for example, a still or moving image that reproduces the brightness of the route along which the movable apparatus 1 should move. Such an image is generated when a brightness indicated by the first condition data and a brightness indicated by the second condition data do not match within a predetermined range. Such an image is generated by processing of bringing a brightness of an image of the route when the map data was generated closer to the brightness indicated by the first condition data.

Alternatively, the non-map data indicates at least one of arrangements and shapes of at least one of objects, rooms, and sections included in the space. In this case, the non-map data indicates, for example, a construction drawing of a room or a section that includes the space in a building, and a position of an object present in the space.

The use determination unit 14 determines the use of the non-map data on the basis of the first condition data and the second condition data and generates the use data that indicates the use of the non-map data. For example, the use determination unit 14 determines that the use of the non-map data is to determine the route for the movable apparatus 1 to move autonomously through the space.

If it is determined that the condition indicated by the first condition data and the condition indicated by the second condition data do not match within the predetermined range, the data provision unit 15 provides the non-map data to the movable apparatus 1.

Also, in this case, the data provision unit 15 may further provide the use data to the movable apparatus 1. On the other hand, if it is determined that the condition indicated by the first condition data and the condition indicated by the second condition data match within the predetermined range, the data provision unit 15 provides the map data to the movable apparatus 1.

When the movable apparatus 1 acquires the non-map data from the data provision unit 15, the movable apparatus 1 generates information required for moving autonomously through the space on the basis of the non-map data. In addition, when the movable apparatus 1 acquires the use data from the data provision unit 15, the movable apparatus 1 generates information required for moving autonomously through the space on the basis of the use data.

Also, when the movable apparatus 1 acquires at least one of the non-map data and the use data, the movable apparatus 1 may further acquire the map data. On the other hand, when the movable apparatus 1 acquires the map data from the data provision unit 15, the movable apparatus 1 generates information required for moving autonomously through the space on the basis of the map data.

Examples of the information required for the movable apparatus 1 to move autonomously through the space include, for example, a position and a posture of the movable apparatus 1 in the space, a position, a dimension, and a shape of an object that may become an obstacle to the movable apparatus 1 when it moves, and the route along which the movable apparatus 1 moves through the space.

For example, the movable apparatus 1 estimates its own position in the space on the basis of the map indicated by the map data and a position and a range of an angle of view of the camera 3 in the space. In addition, for example, the movable apparatus 1 associates feature points or markers of the movable apparatus 1 shown in the still image or video image shown by the image data acquired as the non-map data with feature points or markers of the movable apparatus 1 registered in advance in the server 2 or the like.

Also, examples of such markers include, for example, one-dimensional or two-dimensional codes having white and black areas. Then, the movable apparatus 1 estimates its own posture by correcting the result of associating these two feature points or markers, taking into consideration the position and the range of the angle of view of the camera 3 in the space.

Alternatively, the movable apparatus 1 estimates its own position using the results of the above-described simulation and the map data.

Alternatively, the movable apparatus 1 may determine the route along which it should move on the basis of the non-map data that indicates at least one of the arrangements and the shapes of at least one of the objects, the rooms, and the sections included in the space in which the movable apparatus moves autonomously, and the image data acquired as the non-map data.

Specifically, the movable apparatus 1 determines a rough route along which it should move on the basis of the non-map data that indicates at least one of the arrangements and the shapes of at least one of the objects, the rooms, and the sections included in the space in which the movable apparatus moves autonomously.

Also, the movable apparatus 1 ascertains positions, dimensions, shapes, and the like of objects present along the rough route, and determines a route along which it should finally move, on the basis of on the basis of the image data, and the position and the range of the angle of view of the camera 3 in the space.

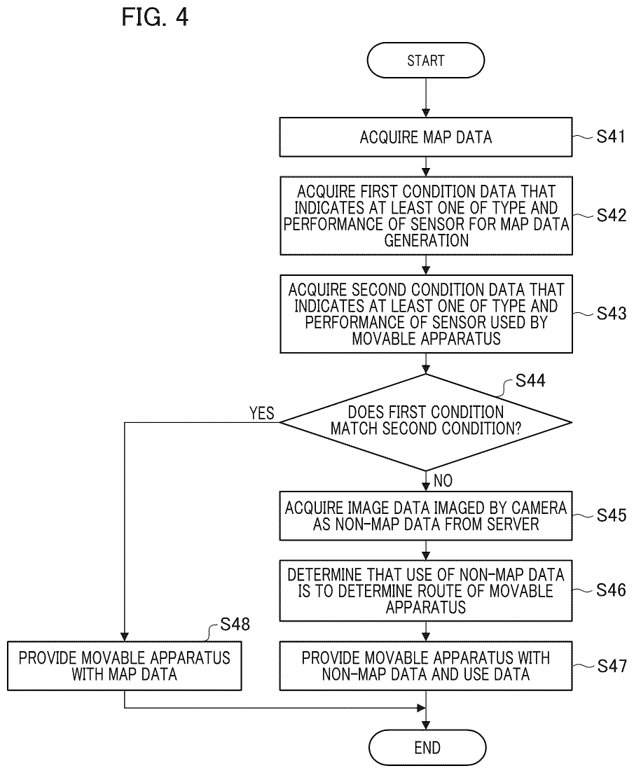

Next, the processing performed by the movable apparatus control device 10 according to the first embodiment will be described with reference to FIG. 4. FIG. 4 is a flowchart showing an example of the processing performed by the movable apparatus control device according to the first embodiment.

In step S41, the movable apparatus control device 10 acquires the map data.

In step S42, the first condition data acquisition unit 11 acquires the first condition data that indicates at least one of the type and the performance of the sensor used to generate the map data acquired in step S41.

In step S43, the second condition data acquisition unit 12 acquires the second condition data that indicates at least one of the type and the performance of the sensor used by the movable apparatus 1 to move autonomously through the space.

In step S44, the non-map data acquisition unit 13 determines whether or not the condition indicated by the first condition data acquired in step S42 and the condition indicated by the second condition data acquired in step S43 match within the predetermined range.

If the non-map data acquisition unit 13 determines that the condition indicated by the first condition data and the condition indicated by the second condition data do not match within the predetermined range (step S44: NO), the process proceeds to step S45.

On the other hand, if the non-map data acquisition unit 13 determines that the condition indicated by the first condition data and the condition indicated by the second condition data match within the predetermined range (step S44: YES), the process proceeds to step S48.

In step S45, the non-map data acquisition unit 13 acquires the image data, which indicates the image generated by imaging at least a part of the space in which the movable apparatus 1 moves, with the camera 3 as the non-map data from the server 4.

In step S46, the use determination unit 14 determines that the use of the non-map data acquired in step S45 is to determine the route of the movable apparatus 1.

In step S47, the data provision unit 15 provides the movable apparatus 1 with the non-map data acquired in step S45 and the use data that indicates the use determined in step S46 to.

In step S48, the data provision unit 15 provides the movable apparatus 1 with the map data acquired in step S41.

### Second Embodiment

Next, a movable apparatus control device according to a second embodiment will be described. Also, in the description of the second embodiment, differences from the first embodiment will be mainly described, and the same contents as those in the first embodiment will be omitted as appropriate.

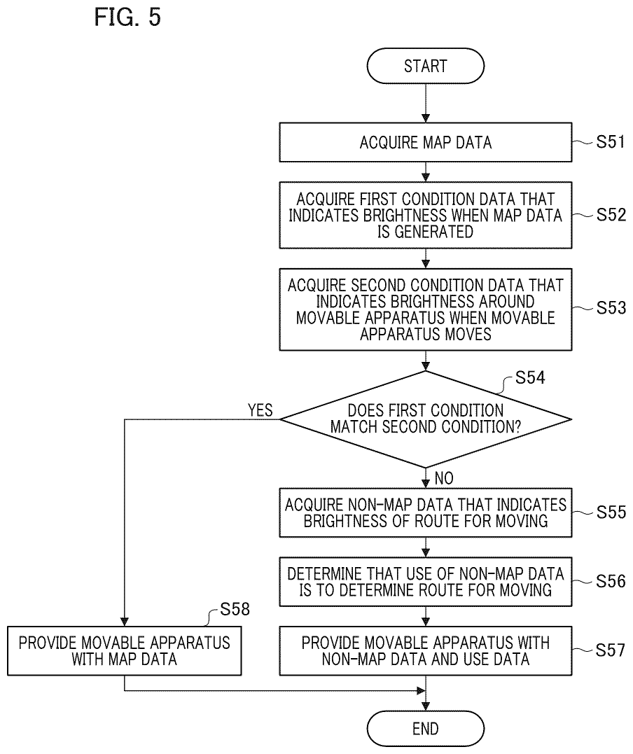

The processing performed by the movable apparatus control device 10 according to the second embodiment will be described with reference to FIG. 5. FIG. 5 is a flowchart showing an example of the processing performed by the movable apparatus control device according to the second embodiment.

In step S51, the movable apparatus control device 10 acquires the map data.

In step S52, the first condition data acquisition unit 11 acquires the first condition data that indicates the brightness around the movable apparatus 1 when the map data acquired in step S51 was generated.

In step S53, the second condition data acquisition unit 12 acquires the second condition data that indicates the brightness around the movable apparatus 1 when the movable apparatus 1 moves autonomously through the space.

In step S54, the non-map data acquisition unit 13 determines whether or not the condition indicated by the first condition data acquired in step S52 and the condition indicated by the second condition data acquired in step S53 match within the predetermined range.

If the non-map data acquisition unit 13 determines that the condition indicated by the first condition data and the condition indicated by the second condition data do not match within the predetermined range (step S54: NO), the process proceeds to step S55.

On the other hand, if the non-map data acquisition unit 13 determines that the condition indicated by the first condition data and the condition indicated by the second condition data match within the predetermined range (step S54: YES), the process proceeds to step S58.

In step S55, the non-map data acquisition unit 13 acquires the non-map data that indicates the result of simulating the brightness of the route that the movable apparatus 1 should move.

In step S56, the use determination unit 14 determines that the use of the non-map data acquired in step S55 is to determine the route of the movable apparatus 1.

In step S57, the data provision unit 15 provides the movable apparatus 1 with the non-map data acquired in step S55 and the use data that indicates the use determined in step S56.

In step S58, the data provision unit 15 provides the movable apparatus 1 with the map data acquired in step S51.

### Third Embodiment

Next, a movable apparatus control device 10 according to a third embodiment will be described. Also, in the description of the third embodiment, differences from the first and second embodiments will be mainly described, and the same contents as those in the first and second embodiments will be omitted as appropriate.

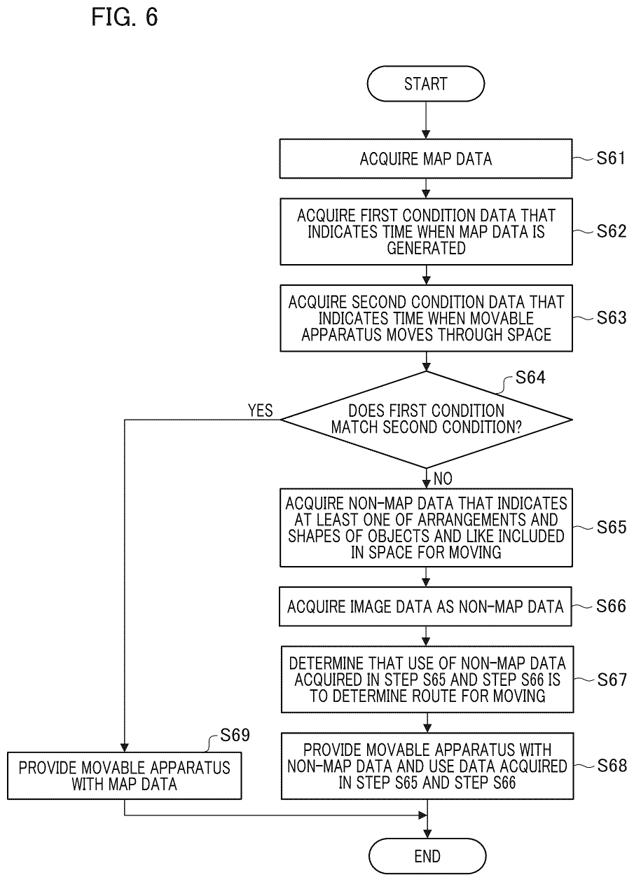

The processing performed by the movable apparatus control device 10 according to the third embodiment will be described with reference to FIG. 6. FIG. 6 is a flowchart showing an example of the processing performed by the movable apparatus control device according to the third embodiment.

In step S61, the movable apparatus control device 10 acquires the map data.

In step S62, the first condition data acquisition unit 11 acquires the first condition data that indicates the time when the map data acquired in step S61 was generated.

In step S63, the second condition data acquisition unit 12 acquires the second condition data that indicates the time for the movable apparatus 1 to move autonomously through the space.

In step S64, the non-map data acquisition unit 13 determines whether or not the condition indicated by the first condition data acquired in step S62 and the condition indicated by the second condition data acquired in step S63 match within the predetermined range.

If the non-map data acquisition unit 13 determines that the condition indicated by the first condition data and the condition indicated by the second condition data do not match within the predetermined range (step S64: NO), the process proceeds to step S65.

On the other hand, if the non-map data acquisition unit 13 determines that the condition indicated by the first condition data and the condition indicated by the second condition data match within the predetermined range (step S64: YES), the process proceeds to step S68.

In step S65, the non-map data acquisition unit 13 acquires the non-map data that indicates at least one of the arrangements and the shapes of at least one of the objects, the rooms, and the sections included in the space in which the movable apparatus 1 moves autonomously.

In step S66, the non-map data acquisition unit 13 acquires the image data as the non-map data.

In step S67, the use determination unit 14 determines that the use of the non-map data acquired in step S65 and the non-map data acquired in step S66 is to determine the route of the movable apparatus 1.

In step S68, the data provision unit 15 provides the movable apparatus 1 with the non-map data acquired in step S66, the non-map data acquired in step S67, and the use data that indicates the use determined in step S67.

In step S69, the data provision unit 15 provides the movable apparatus 1 with the map data acquired in step S61.

Also, if a sufficient number of cameras 3 are installed, the movable apparatus control device 10 may not need to perform step S65. In this case, the movable apparatus control device 10 determines in step S67 only the use of the non-map data acquired in step S66, and provides the movable apparatus 1 with the use data that indicates only the use of the non-map data in step S68.

This is because, if a sufficient number of cameras are installed in the space, the route along with the movable apparatus control device 10 should move can be determined by stitching together still or moving images captured by each camera.

The movable apparatus control device 10 according to the embodiments has been described above. When the condition indicated by the first condition data and the condition indicated by the second condition data do not match within the predetermined range, the above-described movable apparatus control device 10 provides the movable apparatus 1 with the non-map data.

Accordingly, the above-described movable apparatus control device 10 can enable the movable apparatus 1 to move autonomously through the space using the non-map data even when there is a possibility that the movable apparatus 1 may have trouble moving autonomously through the space using only the map data.

In addition, when the condition indicated by the first condition data and the condition indicated by the second condition data do not match within the predetermined range, the above-described movable apparatus control device 10 generates the use data that indicates the use of the non-map data and provides it to the movable apparatus 1. Accordingly, the above-described movable apparatus control device 10 can provide guidance to the movable apparatus 1 when the non-map data is used and enable the movable apparatus 1 to use the non-map data effectively.

Also, the movable apparatus control device 10 according to the third embodiment provides the movable apparatus 1 with the non-map data that indicates at least one of the arrangements and the shapes of at least one of the objects, the rooms, and the sections included in the space.

Accordingly, the movable apparatus control device 10 according to the third embodiment can enable the movable apparatus 1 to move autonomously through the space using the non-map data in spaces in which the layout is often changed frequently, such as factories, commercial facilities, or the like.

In addition, in the above-described embodiments, the sensor mounted on the movable apparatus 1 is LIDAR, a ToF type sensor, or a stereo camera, but the present disclosure is not limited thereto. The sensor mounted on the movable apparatus 1 may be a monocular camera or a depth camera.

Further, the sensor mounted on the movable apparatus 1 may simply detect the presence of each object in the space without ascertaining positions, sizes, shapes, and the like of each object. An example of a sensor that simply detects the presence of an object in the space is an infrared sensor.

In the above-described embodiments, a case in which the movable apparatus control device 10 is mounted on the movable apparatus 1 has been described as an example, but the present disclosure is not limited thereto. The movable apparatus control device 10 does not have to be mounted on the movable apparatus 1. For example, the movable apparatus control device 10 may be mounted on a device other than the movable apparatus 1, or may be a single independent device.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the movable apparatus control device and so on through a network or various storage media. Then, a computer (or a CPU, an MPU, or the like) of the movable apparatus control device and so on may be configured to read and execute the program. In such a case, the program and the storage medium storing the program configure the present invention.

In addition, the present disclosure includes those realized using at least one processor or circuit configured to perform functions of the embodiments explained above. For example, a plurality of processors may be used for distribution processing to perform functions of the embodiments explained above.

What is claimed is:

1. A movable apparatus control device comprising:
at least one processor or circuit configured to function as:
a first condition data acquisition unit configured to acquire first condition data that indicates a condition when map data that indicates a map used when a movable apparatus moves autonomously through a space is generated;
a second condition data acquisition unit configured to acquire second condition data that indicates a condition when the movable apparatus moves autonomously through the space using the map data;
a non-map data acquisition unit configured to acquire non-map data that indicates a content different from the map in a case in which the condition indicated by the first condition data and the condition indicated by the second condition data do not match within a predetermined range; and
a data provision unit configured to provide the non-map data to the movable apparatus.

2. The movable apparatus control device according to claim 1, wherein the at least one processor or circuit is further configured to function as, a use determination unit configured to determine a use of the non-map data on the basis of the first condition data and the second condition data, wherein
the data provision unit is further configured to provide use data to the movable apparatus.

3. The movable apparatus control device according to claim 1, wherein
the first condition data acquisition unit is configured to acquire the first condition data that indicates at least one of: at least one of a type of a sensor and a performance of the sensor used to generate the map data; at least one of a type of sensor and a performance of the sensor used by the movable apparatus to detect an obstacle; a brightness around the movable apparatus when the map data was generated; and a time when the map data was generated, and
the second condition data acquisition unit is configured to acquire the second condition data indicating at least one of: at least one of a type of sensor and a performance of the sensor used for the movable apparatus to move autonomously through the space; at least one of a type of sensor and a performance of the sensor used for the movable apparatus to detect an obstacle; a brightness around the movable apparatus when the movable apparatus moves autonomously through the space; and the time during which the movable apparatus moves autonomously through the space.

4. The movable apparatus control device according to claim 3, wherein
the first condition data acquisition unit is configured to acquire the first condition data that indicates at least one of the type and the performance of the sensor used to generate the map data,
the second condition data acquisition unit is configured to acquire at least one of the type and the performance of the sensor used by the movable apparatus to move autonomously through the space,
the non-map data acquisition unit is configured to acquire the image data that indicates an image generated by imaging at least a part of the space with a camera as the non-map data, and
the use determination unit is configured to determine that the use of the non-map data is to determine a route for the movable apparatus.

5. The movable apparatus control device according to claim 3, wherein
the first condition data acquisition unit is configured to acquire the first condition data that indicates the brightness around the movable apparatus when the map data was generated,
the second condition data acquisition unit is configured to acquire the second condition data that indicates the brightness around the movable apparatus when the movable apparatus moves autonomously through the space,
the non-map data acquisition unit is configured to acquire the non-map data that indicates the result of simulating a brightness of a route along which the movable apparatus should move, and
the use determination unit is configured to determine that the use of the non-map data is to determine a route for the movable apparatus.

6. The movable apparatus control device according to claim 3, wherein
the first condition data acquisition unit is configured to acquire the first condition data that indicates the time when the map data was generated,
the second condition data acquisition unit is configured to acquire the second condition data that indicates the time for the movable apparatus to move autonomously through the space,
the non-map data acquisition unit is configured to acquire the non-map data that indicates at least one of arrangements and shapes of objects, rooms, and sections included in the space, and
the use determination unit is configured to determine that the use of the non-map data is to determine the route for the movable apparatus.

7. The movable apparatus control device according to claim 1, wherein
the non-map data acquisition unit is configured to acquire the non-map data that indicates at least one of: content relating to the sensor used by the movable apparatus; the result of simulating a brightness of a route along which the movable apparatus should move; and at least one of arrangements and shapes of objects, rooms, and sections included in the space.

8. A non-transitory computer-readable storage medium storing a computer program including instructions for executing following processes:
acquiring first condition data that indicates a condition when map data that indicates a map used by a movable apparatus for moving autonomously through a space was generated;
acquiring second condition data that indicates a condition when the movable apparatus moves autonomously through the space using the map data;
acquiring non-map data that indicates content different from the map if the condition indicated by the first condition data and the condition indicated by the second condition data do not match within a predetermined range, and
providing the non-map data to the movable apparatus.

9. A movable apparatus control method comprising:
acquiring first condition data that indicates a condition when map data that indicates a map used by a movable apparatus for moving autonomously through a space was generated;
acquiring second condition data that indicates a condition when the movable apparatus moves autonomously through the space using the map data;
acquiring non-map data that indicates content different from the map if the condition indicated by the first condition data and the condition indicated by the second condition data do not match within a predetermined range, and
providing the non-map data to the movable apparatus.
